(19) United States
(12) Patent Application Publication
(10) Pub. No.: US 2020/0005832 A1
(43) Pub. Date: Jan. 2, 2020

(54) METHOD FOR CALCULATING POSITION COORDINATES AND ELECTRONIC DEVICE

(71) Applicant: Getac Technology Corporation, Hsinchu County (TW)

(72) Inventor: Lu-Ting KO, Taipei (TW)

(21) Appl. No.: 16/021,633

(22) Filed: Jun. 28, 2018

(51) Int. Cl. G11B 27/34; G06T 7/50; G06T 7/70; G01S 19/13

(52) U.S. Cl. CPC G11B 27/34; G06T 7/50; G01S 19/45; G01S 19/13; G06T 2207/30244; G06T 7/70

(57) ABSTRACT

A method for calculating position coordinates includes obtaining an image by a camera module, obtaining at least one set of angle data of the camera module, obtaining first position data of the camera module, obtaining depth information of an image point in the image, and calculating second position data of the image point according to the depth data, the first position data and the at least one set of angle data.

### BACKGROUND OF THE INVENTION

### Field of the Invention

The invention relates to an image processing technology, and more particularly to a method for calculating position coordinates and an electronic device.

### Description of the Prior Art

With the fast development of digital cameras, prices of digital cameras continue to drop, whereas the resolution is ever-increasing and functions of digital cameras are also becoming more diversified. In the recent years, many electronic devices (e.g., smart phones, personal digital assistants and tablet computers) are integrated with a digital camera function (i.e., having an inbuilt camera module) so as to boost competitiveness of electronic products.

To record a shooting location, some electronic products or digital cameras acquire coordinate position information of a shooting location at the time of shooting through an inbuilt Global Positioning System (GPS) module, and records the acquired position information in a file of the photograph captured.

### SUMMARY OF THE INVENTION

A current camera module is capable of only recording a shooting location of a coordinate position through a Global Positioning System (GPS) module, with however detailed positions of various points in the photographed image remaining unknown.

In view of the above, the present invention provides a method for calculating position coordinates and an electronic device so as to obtain actual coordinate positions of various points in an image.

In one embodiment, a method for calculating position coordinates includes obtaining an image by a camera module, obtaining at least one set of angle data of the camera module, obtaining first position data of the camera module, obtaining depth information of an image point in the image, and calculating second position data of the image point according to the depth information, the first position data and the at least one set of angle data.

In one embodiment, an electronic device includes a camera module, a wireless module, at least one angle detecting unit and a processing unit. The camera module shoots a target to generate an image. The at least one angle detecting unit each generates at least one set of angle data. The processing unit obtains depth information of an image point in the image, performs a positioning procedure by using the wireless module to obtain first position data, and calculates second position data of the image point according to the depth data, the first position data and the angle data.

### BRIEF DESCRIPTION OF THE DRAWINGS

FIG. 1 is a schematic diagram of an electronic device according to an embodiment of the present invention;

FIG. 2 is a flowchart of a method for calculating position coordinates according to an embodiment of the present invention;

FIG. 3 is a schematic diagram of an example of position data; and

FIG. 4 is a flowchart of a method for calculating position coordinates according to another embodiment of the present invention.

### DETAILED DESCRIPTION OF THE EMBODIMENTS

The method for calculating position coordinates according to any embodiment of the present invention is applicable to an electronic device, for example but not limited to, a smart phone, a laptop computer, a tablet computer, a vehicle recorder and a digital camera.

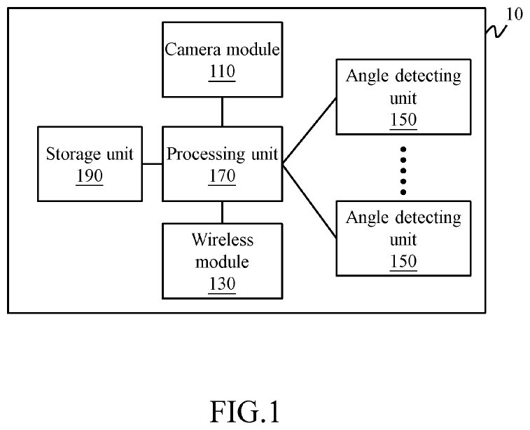

Referring to FIG. 1, the electronic device 10 includes a camera module 110, a wireless module 130, at least one angle detecting unit 150 and a processing unit 170. The processing unit 170 is coupled to the camera module 110, the wireless module 130 and the angle detecting unit 150.

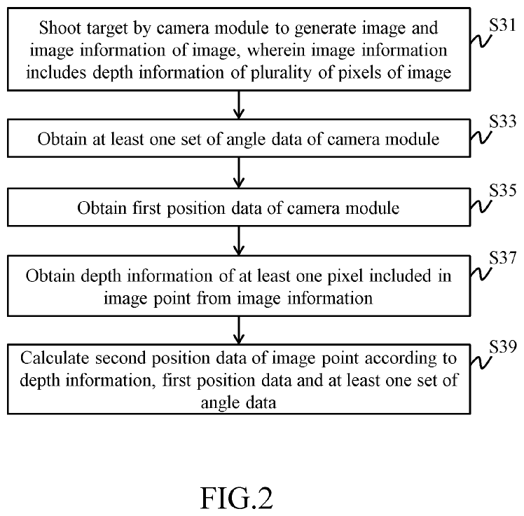

Referring to FIG. 1 and FIG. 2, the camera module 110 shoots a target to generate an image presenting the target (step S31). At this point, the image is formed by a plurality of pixels. The target may be a person, a building, landscape and scenery, or an object. In some embodiments, the processing unit 170 drives the camera module 110 to shoot a target to generate an image presenting the target and image information of the image. In one embodiment, the camera module 110 includes a lens and is provided with an infrared transceiver at the lens. During shooting, the processing unit 170 causes the infrared transceiver to emit light towards the shooting target, calculates depth information of the pixels according to reflected information, and integrates the obtained depth information into the image information of the image. However, in other embodiments, a camera module without an infrared module may also calculate depth information by means similar to parallax of the eye.

In other embodiments, the camera module 110 may include an inbuilt processing unit. The inbuilt processing unit captures an image through the lens and generates image information of the image. Further, the processing unit calculates depth information of the pixels in the image according to the captured image, and integrates the obtained depth information into the image information of the image. In one embodiment, the camera module 110 includes a lens and is provided with an infrared transceiver at the lens. The inbuilt processing unit calculates depth information of the pixels according to reflected information received by the infrared transceiver, and integrates the obtained depth information into the image information of the image. The camera module 110 here may be a 3D camera.

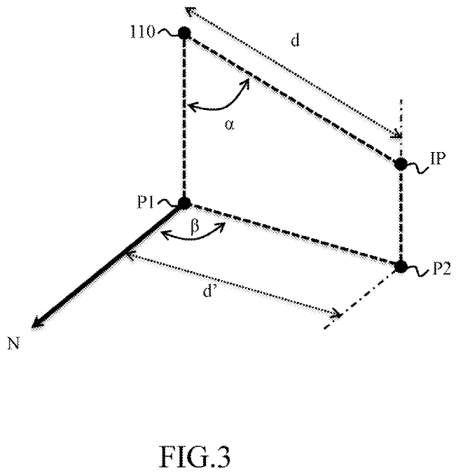

The at least one angle detecting unit 150 each generates at least one set of angle data of the camera module 110 and provides to the processing unit 170 (step S33). In other words, each angle detecting unit 150 generates one set of angle data of the camera module 110. In some embodiments, the at least one set of angle data includes a plumb line angle α and an azimuth angle β, as shown in FIG. 3. That is, the angle detecting unit 150 includes a plumb line angle detecting unit and an azimuth angle detecting unit. The plumb line angle detecting unit may be, e.g., a G-sensor, and learns the plumb line angle α based on measuring the G-force direction. The azimuth angle detecting unit may be, e.g., an E-compass, and learns the azimuth angle β based on an included angle between the pointer of the compass and the North Pole. However, in other embodiments, the azimuth angle β may be learned based on an included angle between the pointer of the compass and the South Pole.

Referring to FIG. 1 to FIG. 3, the processing unit 170 performs a positioning procedure by using the wireless module 130 to obtain position data (to be referred to as first position data P1) of the camera module 110 (step S35). In this embodiment, the first position data P1 indicates the position of the camera module 110 vertically projected on the Earth, and may include a longitude coordinate (which may be converted to an X-coordinate of a horizontal orthogonal coordinate system) and a latitude coordinate (which may be converted to a Y-coordinate of a horizontal orthogonal coordinate system) according to the longitude and the latitude (also referred to as a geographic coordinate system). The converted longitude and latitude coordinates are respectively referred to as a first X-coordinate x1 and a first Y-coordinate y1 below, or the coordinates (x1, y1) are directly regarded as an origin of a horizontal orthogonal coordinate system. In some embodiments, the wireless module 130 may be a GPS module, a Wi-Fi module, or a Bluetooth module. In an exemplary positioning procedure, when the wireless module 130 is a GPS module, the processing unit 170 obtains current longitude and latitude coordinates of the camera module 110 according to GPS signals of the GPS module. Details of the algorithm of a positioning procedure based on GPS signals are generally known, and are omitted herein. In another exemplary positioning procedure, when the wireless module 130 is a Wi-Fi module, the processing unit 170 obtains current longitude and latitude coordinates of the camera module 110 according to Wi-Fi signals of the Wi-Fi module. Details of the algorithm of a positioning procedure based on Wi-Fi signals are generally known, and are omitted herein. In another exemplary positioning procedure, when the wireless module 130 is a Bluetooth module, the processing unit 170 obtains current longitude and latitude coordinates of the camera module 110 according to Bluetooth signals of the Bluetooth module. Details of the algorithm of a positioning procedure based on Bluetooth signals are generally known, and are omitted herein.

The processing unit 170 is further capable of calculating and generating actual position data (to be referred to as second position data P2) of any point (to be referred to as an image point IP) in an image. The image point IP may be a pixel or may be multiple adjacent pixels. An example of calculating the second position data P2 of one image point IP is described below.

The processing unit 170 obtains depth information d according to a selected image point IP in an image (step S37). In some embodiments, the processing unit 170 obtains depth information d of a pixel point included in the selected image point IP from image information of the image. In some embodiments, when the image point IP includes multiple pixels, the depth information d of the image point IP may be an average of the depth information of these pixels.

The processing unit 170 further calculates position data (to be referred to as second position data P2) of the image point IP according to the depth information d of the image point IP, the first position data P1 and the angle data (step S39). In this embodiment, the second position data P2 indicates the position of the image point IP vertically protected on the Earth, and may include a longitude coordinate (which may be converted to an X-coordinate of a horizontal orthogonal coordinate system) and a latitude coordinate (which may be converted to a Y-coordinate of a horizontal orthogonal coordinate system) according to the longitude and the latitude (also referred to as a geographic coordinate system). The converted longitude and latitude coordinates are respectively referred to as a second X-coordinate x2 and a second Y-coordinate y2 below, or the coordinates (x2, y2) are directly regarded as orthogonal coordinates relative to the origin. Thus, the respective positions of the camera module 110 and the image point IP vertically projected on the Earth are (x1, y1) and (x2, y2) assuming that a horizontal orthogonal coordinate system is adopted; if (x1, y1) are regarded as the origin of the horizontal orthogonal coordinate system, (x1, y1)=(0, 0).

In some embodiments, the processing unit 170 calculates a horizontal distance d′ according to the depth information d of the image point IP and the angle data of the camera module 110, wherein the angle data is the plumb line angle α between 0 and 180 degrees and a sine value thereof is a non-negative number. In this embodiment, because the height of the image point IP is slightly lower than that of the camera module 110, a connecting line between the two is slightly lower than a horizontal plane where the camera module 110 is located, and hence the plumb line angle α of the camera module 110 is a complementary angle of a depression angle and may be directly learned based on measuring the G-force direction. However, in other embodiments, if the height of the image point IP is slightly higher than that of the camera module 110, the connecting line between the two is then slightly higher than the horizontal plane where the camera module 110 is located, and hence the plumb line angle α of the camera module 110 is an elevation angle plus 90 degrees and may also be directly learned based on measuring the G-force direction. Next, the processing unit 170 calculates the second X-coordinate according to the first X-coordinate x1, the horizontal distance d′ and the azimuth angle β of the camera module 110, and calculates the second Y-coordinate according to the first Y-coordinate y1, the horizontal distance d′ and the azimuth angle β of the camera module 110.

For example, referring to FIG. 3, the first position data P1 of the camera module 110 is (x1, y1), where x1 is the first X-coordinate and y1 is the first Y-coordinate. The second position data P2 of the image point IP is (x2, y2), where x2 is the second X-coordinate and y2 is the second Y-coordinate. The depth information d of the image point IP indicates a straight line distance d between the actual position of the image point IP and the camera module 110, i.e., the connecting line length d between the two. In this embodiment, the complementary angle α of the elevation angle of the camera module 110 is an included angle between the straight line distance and the vertical direction. At this point, the processing unit 170 calculates the horizontal distance d′ between the actual position of the image point IP and the camera module 110, i.e., the length of the depth data d or the connecting line length d vertically projected on the horizontal plane, according to equation (1) below:

d′=d×sin(α) (1)

In this embodiment, the azimuth angle β of the camera module 110 is an included angle between the horizontal distance d′ and due north of the ground horizon, wherein the due north of the ground horizon is a due Y-direction of the horizontal orthogonal coordinate system. As such, the processing unit 170 calculates the second position data P2 of the image point IP according to equations (2) and (3) below:

x2=x1+d′×sin(β) (2)

y2=y1+d′×cos(β) (3)

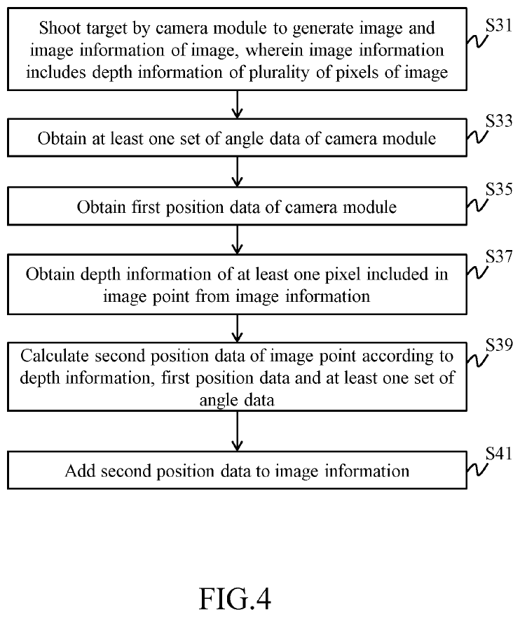

In some embodiments, referring to FIG. 4, after the processing unit 170 obtains the second position data P2 of the image point IP, the processing unit 170 may further add the second position data P2 to the image information of the image (step S41).

In some embodiments, the foregoing processing unit may be a microprocessor, a microcontroller, a digital signal processor, a central processor, a programmable logic controller, a state machine or any analog and/or digital devices operating signals based on operation instructions.

In some embodiments, the electronic device 10 may further include one or more storage units 190. In one embodiment, the storage unit 190 may be coupled to the processing unit 170 (as shown in FIG. 1). In another embodiment, the storage unit 190 may be built in the processing unit 170 (not shown).

The storage unit 190 stores software/firmware programs for realizing the method for calculating position coordinates of the present invention, associated information and data, or any combinations thereof. Each storage unit 190 may be implemented by one or more memories.

In some embodiments, the method for calculating position coordinates of the present invention may be realized by a computer program product, such that the method for calculating position coordinates according to any embodiment of the present invention can be completed after the electronic device 10 loads and executes the program. In some embodiments, the computer program product may be a readable recording medium, and the above program is stored in the readable recording medium and is to be loaded by the electronic device 10. In some embodiments, the above program may be a computer program product, and is transmitted to the electronic device 10 by wired or wireless means.

In conclusion, the method for calculating position coordinates and the electronic device of the present invention are capable of providing actual position data (longitude and latitude coordinates) of each point in an image.

What is claimed is:

1. A method for calculating position coordinates, comprising:
obtaining image by a camera module;
obtaining at least set of angle data of the camera module;
obtaining first position data of the camera module;
obtaining depth information of an image point in the image; and
calculating second position information of the image point according to the depth information, the first position data and the at least one set of angle data.

2. The method for calculating position coordinates according to claim 1, wherein the at least one set of angle data comprises a plumb line angle and an azimuth angle of the camera module.

3. The method for calculating position coordinates according to claim 2, wherein the first position data of the camera module comprises a first X-coordinate and a first Y-coordinate, and the step of calculating the second position data of the image point according to the depth information, the position data and the at least one set of angle data comprises:
calculating a horizontal distance according to the depth information and the plumb line angle;
calculating a second X-coordinate according to the first X-coordinate, the horizontal distance and the azimuth angle; and
calculating a second Y-coordinate according to the first Y-coordinate, the horizontal distance and the azimuth angle.

4. The method for calculating position coordinates according to claim 1, wherein image information comprises depth information of a plurality of pixels of the image, and the step of obtaining the depth information of the image point comprises:
obtaining the depth information of at least one of the pixels comprised in the image from the image information.

5. The method for calculating position coordinates according to claim 4, further comprising:
adding the second position data to the image information.

6. The method for calculating position coordinates according to claim 1, wherein the step of obtaining the position data of the camera module comprises:
generating the first position data by performing a positioning procedure by using a wireless module.

7. The method for calculating position coordinates according to claim 6, wherein the wireless module is a wireless network module, a Global Positioning System (GPS) module or a Bluetooth module.

8. An electronic device, comprising:
a camera module, shooting a target to generate an image;
a wireless module;
at least one angle detecting unit, each generating at least one set of angle data; and
a processing unit, obtaining depth information of an image point in the image, performing a positioning procedure to obtain first position data, and calculating second position data of the image point according to the depth information, the first position data and the at least one set of angle data.

9. The electronic device according to claim 8, wherein the wireless module is a wireless network module, a Global Positioning System (GPS) module or a Bluetooth module.

10. The electronic device according to claim 8, wherein the at least one set of angle data comprises a plumb line angle and an azimuth angle.
